(19) United States
(12) Patent Application Publication
(10) Pub. No.: US 2003/0223442 A1
(43) Pub. Date: Dec. 4, 2003

(54) Buffer memory reservation

(76) Inventors: Anguo T. Huang, Mountain View, CA (US); Jean-Michel Caia, San Francisco, CA (US); Jing Ling, Fremont, CA (US); Juan-Carlos Calderon, Fremont, CA (US); Vivek Joshi, Sunnyvale, CA (US)

Correspondence Address: FISH & RICHARDSON, PC, 4350 LA JOLLA VILLAGE DRIVE, SUITE 500, SAN DIEGO, CA, 92122, US

(21) Appl. No.: 10/158,291

(22) Filed: May 29, 2002

(51) Int. Cl. H04L 12/28; H04J 3/24

(52) U.S. Cl. 370/412; 370/473; 370/398

(57) ABSTRACT

Network applications may require a guaranteed rate of throughput, which may be accomplished by using buffer memory reservation to manage a data queue used to store incoming packets. Buffer memory reservation reserves a portion of a data queue as a dedicated queue for each flow, reserves another portion of a data queue as a shared queue, and associates a portion of the shared queue with each flow. The amount of the buffer memory reserved by the dedicated queue sizes and the shared queue portion sizes for all of the flows may exceed the amount of physical memory available to buffer incoming packets.

### BACKGROUND

The following description relates to a digital communication system, and more particularly to a system that includes a high speed packet-switching network that transports packets. High speed packet-switching networks, such as Asynchronous Transfer Mode (ATM), Internet Protocol (IP), and Gigabit Ethernet, support a multitude of connections to different sessions in which incoming packets compete for space in a buffer memory.

Digital communication systems typically employ packet-switching systems that transmit blocks of data called packets. Typically, a message or other set of data to be sent is larger than the size of a packet and must be broken into a series of packets. Each packet consists of a portion of the data being transmitted and control information in a header used to route the packet through the network to its destination.

### DESCRIPTION OF DRAWINGS

FIG. 1 is a diagram of a packet-switching network.

FIG. 2 is a diagram of buffer memory used to store incoming packets.

FIG. 3 is a state diagram for a process performed to reserve buffer memory space to store incoming packets.

FIGS. 4, 5 and 6 are flow charts illustrating processes for reserving buffer memory space to store incoming packets.

Like reference symbols in the various drawings indicate like elements.

### DETAILED DESCRIPTION

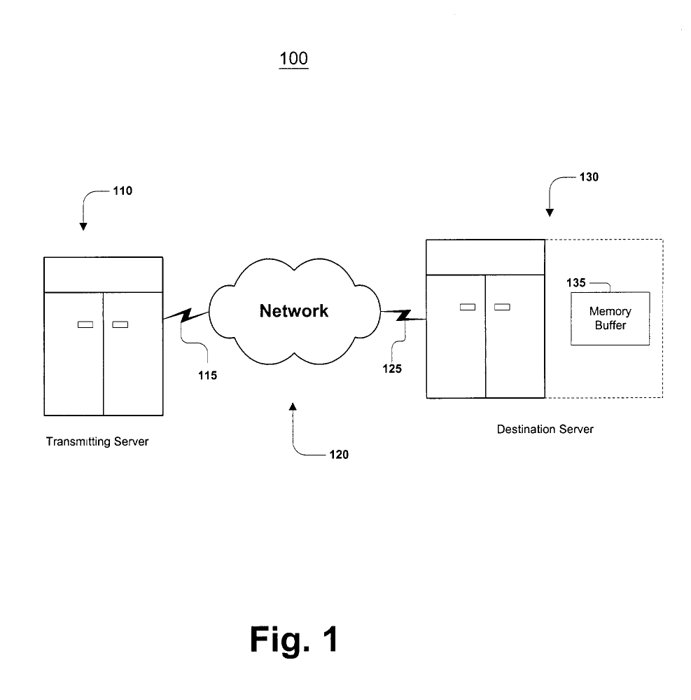

FIG. 1 shows a typical packet-switching system that includes a transmitting server 110 connected through a communication pathway 115 to a packet-switching network 120 that is connected through a communication pathway 125 to a destination server 130. The transmitting server 110 sends a message through the packet-switching network 120 to the destination server 130 as a series of packets. In the packet-switching network 120, the packets typically pass through a series of servers. As each packet arrives at a server, the server stores the packet briefly in buffer memory before transmitting the packet to the next server. The packet proceeds through the network until it arrives at the destination server 130, which stores the packet briefly in buffer memory 135 as the packet is received.

High-speed packet-switching networks are capable of supporting a vast number of connections (also called flows). Some broadband networks, for example, may support in each line card 256,000 connections through 64 logical ports. Each incoming packet from a flow may be stored in a data queue in buffer memory upon receipt. If no buffer memory space is available to store a particular packet, the incoming packet is dropped.

Network applications may require a guaranteed rate of throughput, which may be accomplished by using buffer memory reservation to manage a data queue used to store incoming packets. Buffer memory reservation reserves a portion of a data queue as a dedicated queue for each flow, reserves another portion of a data queue as a shared queue, and associates a portion of the shared queue with each flow. The dedicated queue size provided to each flow provides a guaranteed rate of throughput for incoming packets, and the shared queue provides space to buffer packets during periods having peak rates that exceed the guaranteed rate of throughput. The dedicated queue may have one or more reserved memory addresses assigned to it or may be assigned memory space without reference to a particular reserved memory address. Similarly, the shared queue may have one or more reserved memory addresses assigned to it or may be assigned memory space without reference to a particular reserved memory address. The amount of the buffer memory reserved by the dedicated queue portions and the shared queue portion for all of the flows may exceed the amount of physical memory available to buffer incoming packets. However, the amount of buffer memory reserved by the dedicated queue portions may not exceed the amount of physical memory available to buffer incoming packets.

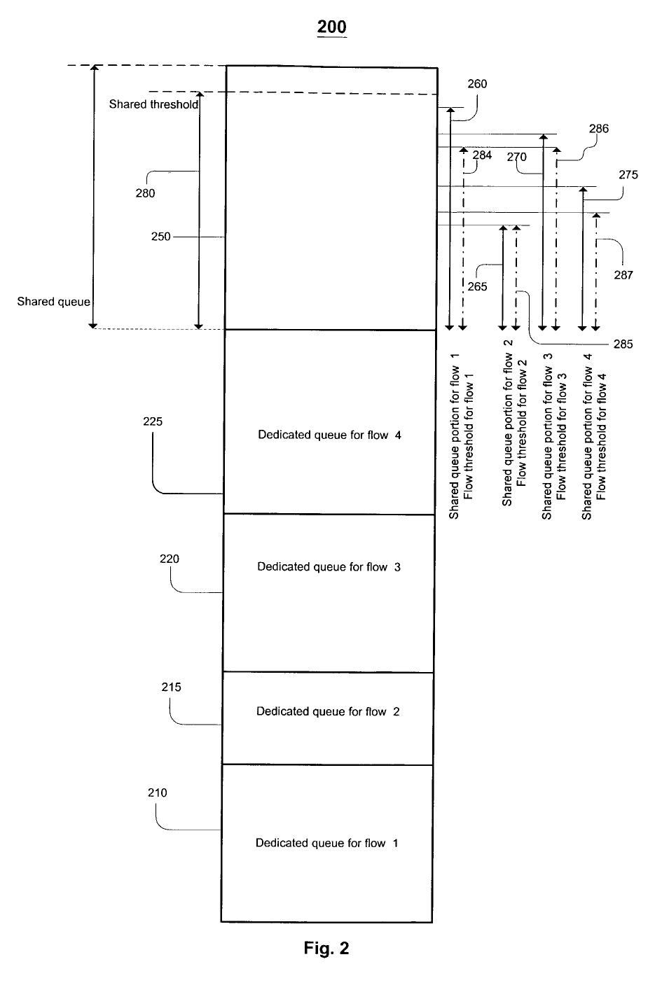

As shown in FIG. 2, the buffer memory for a data queue 200 used to store incoming packets is apportioned into queues 210, 215, 220, and 225 dedicated to each flow and a shared queue 250. For brevity, FIG. 2 illustrates only a small portion of data queue 200. The portion of the shared queue 250 associated with each flow is shown by arrows 260, 265, 270, 275. Eighty percent of the shared queue size is associated with a first flow in portion 260, forty eighty percent of the shared queue size is associated with a second flow in portion 265, seventy-five percent of the shared queue size is associated with a third flow in portion 270, and fifty-five percent of the shared queue size is associated with a fourth flow in portion 275. The sum of the sizes of the dedicated queues 210, 215, 220, 225 and the sizes of the shared queue portions 260, 265, 270, 275 exceeds the amount of physical memory available to store incoming packets.

The unused portion of the data queue 200 may decrease during the time period from when the determination is made that space is available in the data queue to store a particular incoming packet to when the particular incoming packet is stored. Such a decrease in the unused portion of the data queue may prevent the particular incoming packet from being stored, and may result in the incoming packet being dropped.

A shared threshold 280 that is less than the size of the shared queue may reduce the number of incoming packets that are dropped because of such a data queue increase. The shared threshold 280 may be set to a value that is less than or equal to the size of the shared queue 250, with the actual value of the threshold being selected based on a balance between the likelihood of dropping packets (which increases as the shared threshold increases) and the efficiency with which the shared queue is used (which decreases as the shared threshold decreases). In addition, a flow threshold 284-287 that is less than or equal to the size of the shared queue portion 260, 265, 270, 275 associated with the flow may be set for each flow.

The size of the dedicated queues used in buffer memory reservation implementations may be the same for all flows or may vary between flows. An implementation may use the same flow threshold values for all flows, may vary the flow threshold values between flows, or may use no flow thresholds.

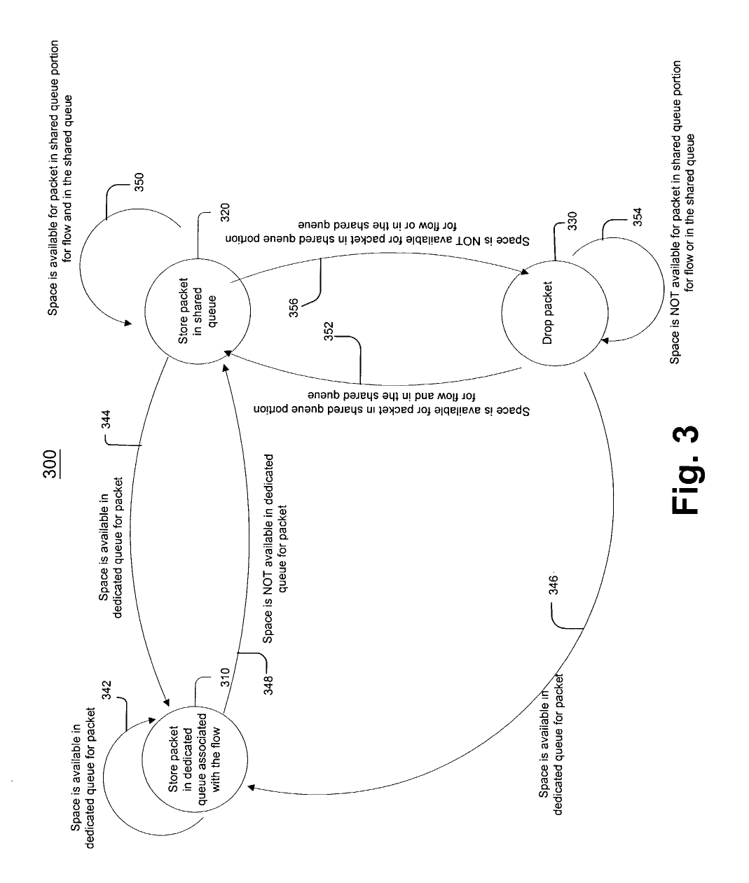

FIG. 3 illustrates a state diagram 300 for execution of buffer memory reservation on a processor. After receiving an incoming packet, the processor may store the incoming packet from a flow in the dedicated queue associated with the flow (state 310), may store the incoming packet in the shared queue (state 320), or may drop the packet (state 330).

The processor stores the incoming packet from a flow in the dedicated queue associated with the flow (state 310) if space is available in the dedicated queue for the packet (transitions 342, 344, 346). For a particular flow, the processor remains in state 310 (transition 342) until the dedicated queue for the flow is full.

When space is not available in the dedicated queue (transition 348), the incoming packet may be stored in the shared queue (state 320) if space is available in the shared queue portion for the flow and in the shared queue (transition 350). Space must be available both in the shared queue portion for the flow and the shared queue because the physical memory available to the shared queue may be less than the amount of space allocated to the sum of the shared queue portions for all of the flows. When there is no space available to store the incoming packet in the shared queue or the dedicated queue (transitions 354, 356), the incoming packet is dropped from the flow of packets (state 330). The processor continues to drop incoming packets until space becomes available in the shared queue (transition 352) or the dedicated queue (transition 346).

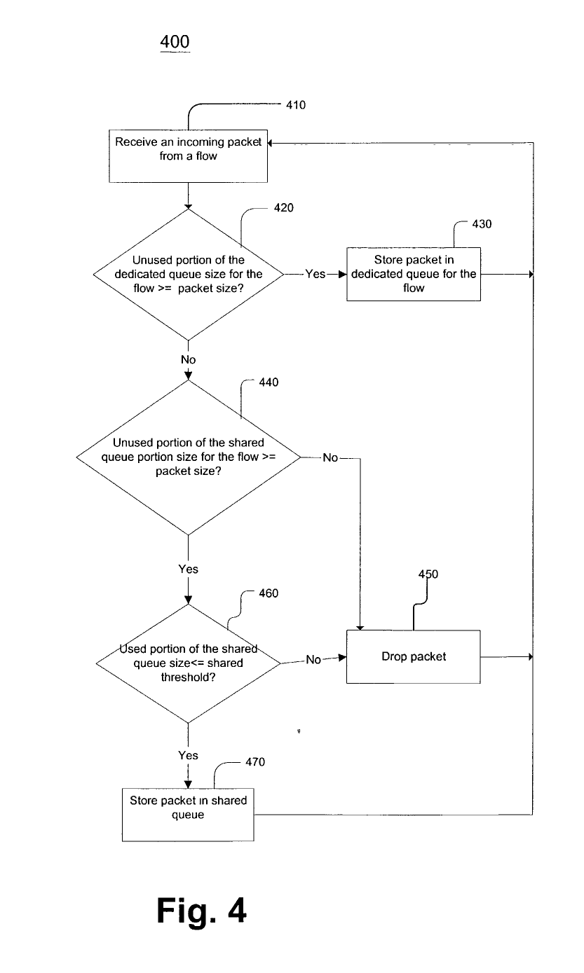

Referring to FIG. 4, a process 400 uses the size of the incoming packet to determine whether space is available in the shared queue portion for a flow. The implementation of the process 400 in FIG. 4 uses a shared threshold for the shared queue that is equal to the size of the shared queue and does not associate a flow threshold with the flow from which the incoming packets are received.

The process 400 begins when a processor receives an incoming packet from a flow (410). The processor determines whether the unused portion of the dedicated queue size for the flow is greater than or equal to the packet size (420). If so, the processor stores the packet in the dedicated queue for the flow (430) and waits to receive another incoming packet from a flow (410).

If the processor determines that the unused portion of the dedicated queue size is less than the packet size (e.g., space is not available to store the packet in the dedicated queue for the flow), the processor determines whether the size of the unused portion of the shared queue portion for the flow is greater than or equal to the packet (440), and, if not, drops the packet (450). The packet is dropped because neither the dedicated queue for the flow nor the shared queue portion for the flow has sufficient space available to store the packet. After dropping the packet, the processor waits to receive another incoming packet (410).

If the processor determines that the size of the unused portion of the shared queue portion for the flow is greater than or equal to the packet size, the processor determines whether the used portion of the shared queue is less than or equal to the shared threshold (460). If so, the processor stores the packet in the shared queue (470) and waits to receive another incoming packet from a flow (410). If the processor determines that the used portion of the shared queue size is greater than the shared threshold, the processor drops the packet (450) and waits to receive an incoming packet from a flow (410).

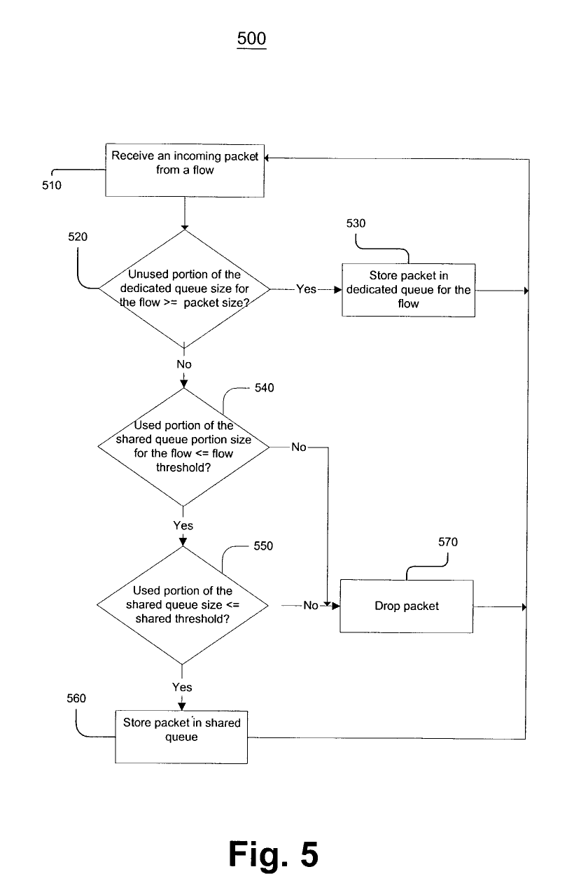

Referring to FIG. 5, a process 500 uses a flow threshold to determine whether space is available in the shared queue portion for a flow. The process 500 uses a shared threshold for the shared queue that is less than the size of the shared queue and associates with each flow a flow threshold that is less than the size of the shared queue portion associated with the flow.

The process 500 begins when a processor receives an incoming packet from a flow (510), determines whether the dedicated queue for the flow has space available for the packet (520), and, when space is available, stores the incoming packet in the dedicated queue for the flow (530). If space is not available in the dedicated queue for the flow (520), the processor determines whether the used portion of the shared queue portion is less than or equal to the flow threshold (540). This is in contrast to the implementation described with respect to FIG. 4, where the processor determines whether the shared queue portion has space available based on the size of the incoming packet and does not use a flow threshold.

If the flow threshold is satisfied, the processor determines whether the used portion of the shared queue is less than or equal to the shared threshold (550). The processor stores the packet in the shared queue (560) only if the used portions of the shared queue portion and the shared queue are less than or equal to their respective thresholds. Otherwise, the processor drops the incoming packet (570). The processor then waits for an incoming packet (510) and proceeds as described above.

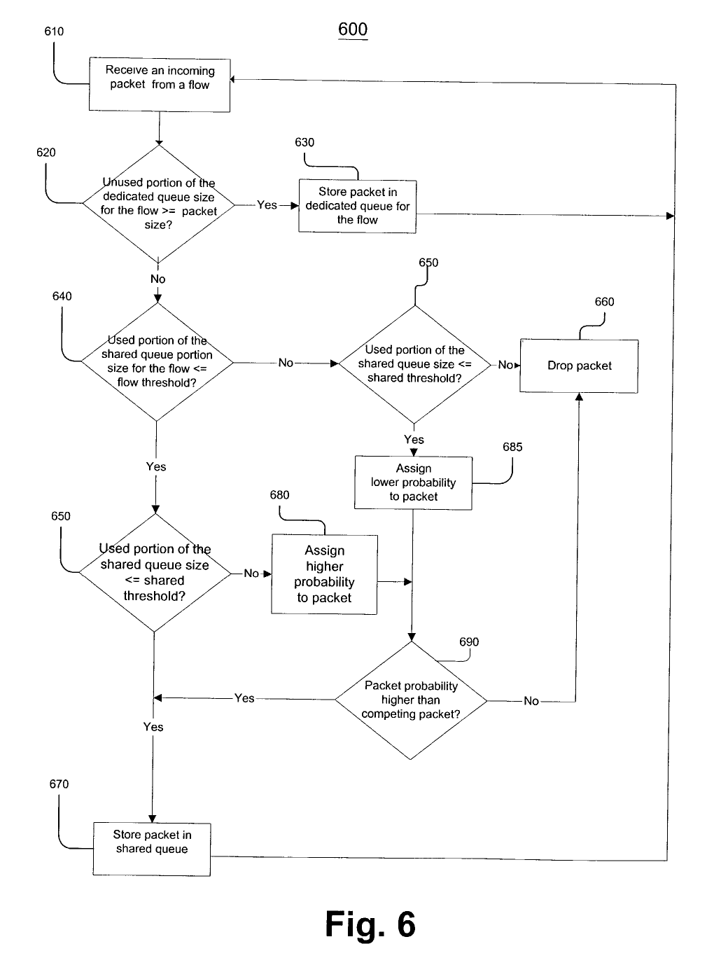

Referring to FIG. 6, a process 600 assigns a probability of being accepted into the shared queue to a particular received packet and accepts the received packet into the shared queue when the particular packet has a higher probability of being accepted than the probabilities assigned to other incoming packets that are competing for buffer memory space.

The process 600 begins when a processor receives an incoming packet from a flow (610), determines whether the dedicated queue for the flow has space available for the packet (620), and, when space is available, stores the incoming packet in the dedicated queue for the flow (630). If space to store the packet is not available in the dedicated queue for the flow, the processor determines whether the used portion of the shared queue portion for the flow is less than or equal to the flow threshold (640) and determines whether the used portion of the shared queue is less than or equal to the shared threshold (650). Based on those determinations, the processor may drop the packet or store the packet in the shared queue as set forth in the table below.

| Used portion | Used portion | | |
|---|---|---|---|
| of the shared | of the shared | Assign | |
| queue portion | queue less | probability | |
| less than or | than or equal | to | |
| equal to flow | to shared | packet | |
| threshold | threshold | (optional) | Storage result |
| Yes | Yes | | Store packet in shared |
| | | | queue |
| Yes | No | Assign | Store packet in shared |
| | | higher | queue if packet probability |
| | | probability | is higher than competing |
| | | to packet | packets; else drop packet |
| No | Yes | Assign | Store packet in shared |
| | | lower | queue if packet probability |
| | | probability | is higher than competing |
| | | to packet | packets; else drop packet |
| No | No | | Drop packet |

The packet is dropped (660) when the used portion of the shared queue portion is greater than the flow threshold and the used portion of the shared queue is greater than the shared threshold.

The packet is stored in the shared queue (670) when the used portion of the shared queue portion is less than or equal to the flow threshold and the used portion of the shared queue size is less than or equal to the shared threshold.

If neither of those two conditions exist, the processor assigns the packet a higher probability of being stored in the shared queue (680) when the used portion of the shared queue portion is less than or equal to the flow threshold and the used portion of the shared queue is greater than the shared threshold. The processor assigns the packet a lower probability of being stored in the shared queue (685) when the used portion of the shared queue portion is greater than the flow threshold and the used portion of the shared queue is less than or equal to the shared threshold. The processor then determines whether the probability assigned to the packet is greater than the probability assigned to other incoming packets that are competing for buffer memory space (690). If so, the processor stores the packet in the shared queue (670; otherwise, the packet is dropped (660).

Buffer memory reservation helps to provide a guaranteed rate of throughput for incoming packets and to avoid buffer congestion. Buffer memory reservation techniques provide a variety of parameters that can be used to manage the network application, including a shared threshold, a flow threshold for each flow, a dedicated queue for each flow, a shared queue, and a shared queue portion for each flow. Some implementations may predesignate parameters, while other implementations may vary the parameters based on current network conditions.

The benefits of buffer memory reservation for packet applications are applicable to other implementations of packet-switching networks that use fixed-length or variable-length packets.

Implementations may include a method or process, an apparatus or system, or computer software on a computer medium. It will be understood that various modifications may be made without departing from the spirit and scope of the following claims. For example, advantageous results still could be achieved if steps of the disclosed techniques were performed in a different order and/or if components in the disclosed systems were combined in a different manner and/or replaced or supplemented by other components.

What is claimed is:

1. A buffer memory management method for a packet-switching application, the method comprising:
associating each of a plurality of flows of packets with a dedicated queue and a particular portion of a shared queue to provide a size of a combination of the dedicated queues and the shared queue portions for all of the flows exceeding an amount of physical memory available to buffer packets, and
accepting a particular packet from a particular flow of packets into the dedicated queue associated with the particular flow if a size of an unused portion of the dedicated queue associated with the particular flow is greater than or equal to a size of the particular packet.

2. The method of claim 1 wherein the size of the dedicated queue varies for different flows.

3. The method of claim 1 wherein the size of the dedicated queue is the same for all flows.

4. The method of claim 1 further comprising:
setting a shared threshold that is less than or equal to a size of the shared queue, and
accepting a particular packet from a particular flow of packets into the shared queue if the particular packet is not accepted by the dedicated queue associated with the particular flow, a size of an unused portion of the shared queue portion associated with the particular flow is greater than or equal to the size of the particular packet, and a size of a used portion of the shared queue is less than or equal to the shared threshold.

5. The method of claim 4 further comprising dropping a particular packet from a particular flow of packets if the particular packet is not accepted by the dedicated queue associated with the particular flow and a size of a used portion of the shared queue is greater than the shared threshold.

6. The method of claim 4 further comprising dropping a particular packet from the particular flow of packets if the particular packet is not accepted by the dedicated queue associated with the particular flow and the size of the unused portion of the shared queue portion associated with the particular flow is less than the size of the particular packet.

7. The method of claim 4 further comprising:
associating each flow of packets with a flow threshold, and
dropping a particular packet from the particular flow of packets if the particular packet is not accepted by the dedicated queue associated with the particular flow and a size of the used portion of the shared queue portion associated with the particular flow is greater than the flow threshold associated with the particular flow.

8. The method of claim 1 further comprising:
associating each received packet with a probability of being accepted into the shared queue,
accepting a particular packet from a particular flow of packets into the shared queue if the particular packet is not accepted by the dedicated queue associated with the particular flow and the probability associated with the particular packet is greater than the probability associated with one or more other received packets that have not been accepted by the dedicated queues associated with the flows of the received packets, and
dropping a particular packet from a particular flow of packets if the particular packet is not accepted into the dedicated queue associated with the particular flow and the particular packet is not accepted into the shared queue.

9. The method of claim 8, wherein the shared threshold is less than the size of the shared queue, the method further comprising:
associating each flow of packets with a flow threshold;
associating a particular packet from a particular flow of packets with a first probability if:
the particular packet is not accepted by the dedicated queue associated with the particular flow,
the size of the used portion of the shared queue is greater than the shared threshold, and
the size of the used portion of the shared queue portion is less than or equal to the flow threshold associated with a particular flow; and
associating a particular packet from a particular flow of packets with a second probability if:
the particular packet is not accepted by the dedicated queue associated with the particular flow,
the size of the used portion of the shared queue is less than or equal to the shared threshold, and
the size of the used portion of the shared queue portion is greater than the flow threshold associated with the particular flow;
wherein the first probability is less than the second probability.

10. A computer readable medium or propagated signal having embodied thereon a computer program configured to cause a processor to implement buffer memory management for a packet-switching application, the computer program comprising code segments for causing a processor to:
associate each of a plurality of flows of packets with a dedicated queue and a particular portion of a shared queue to provide a size of a combination of the dedicated queues and the shared queue portions for all of the flows exceeding an amount of physical memory available to buffer packets, and
accept a particular packet from a particular flow of packets into the dedicated queue associated with the particular flow if a size of an unused portion of the dedicated queue associated with the particular flow is greater than or equal to a size of the particular packet.

11. The medium of claim 10 wherein the size of the dedicated queue varies for different flows.

12. The medium of claim 10 wherein the size of the dedicated queue is the same for all flows.

13. The medium of claim 10 further comprising code segments for causing a processor to:
set a shared threshold that is less than or equal to the shared queue size, and
accept a particular packet from a particular flow of packets into the shared queue if the particular packet is not accepted by the dedicated queue associated with the particular flow, a size of an unused portion of the shared queue portion associated with the particular flow is greater than or equal to the size of the particular packet, and a size of a used portion of the shared queue is less than or equal to the shared threshold.

14. The medium of claim 13 further comprising code segments for causing a processor to drop a particular packet from a particular flow of packets if the particular packet is not accepted by the dedicated queue associated with the particular flow and a size of a used portion of the shared queue is greater than the shared threshold.

15. The medium of claim 13 further comprising code segments for causing a processor to drop a particular packet from the particular flow of packets if the particular packet is not accepted by the dedicated queue associated with the particular flow and the size of the unused portion of the shared queue portion associated with the particular flow is less than the size of the particular packet.

16. The medium of claim 13 further comprising code segments for causing a processor to:
associate each flow of packets with a flow threshold, and
drop a particular packet from the particular flow of packets if the particular packet is not accepted by the dedicated queue associated with the particular flow and a size of the used portion of the shared queue portion associated with the particular flow is greater than the flow threshold associated with the particular flow.

17. The medium of claim 10 further comprising code segment for causing a processor to:
associate each received packet with a probability of being accepted into the shared queue,
accept a particular packet from a particular flow of packets into the shared queue if the particular packet is not accepted by the dedicated queue associated with the particular flow and the probability associated with the particular packet is greater than the probability associated with one or more other received packets that have not been accepted by the dedicated queues associated with the flows of the received packets, and
drop a particular packet from a particular flow of packets if the particular packet is not accepted into the dedicated queue associated with the particular flow and the particular packet is not accepted into the shared queue.

18. The medium of claim 17, wherein the shared threshold is less than the shared queue size, the medium further comprising code segments for causing a processor to:
associate each flow of packets with a flow threshold;
associate a particular packet from a particular flow of packets with a first probability if:
the particular packet is not accepted by the dedicated queue associated with the particular flow,
the size of the used portion of the shared queue is greater than the shared threshold, and
the size of the used portion of the shared queue portion is less than or equal to the flow threshold associated with a particular flow; and
associate a particular packet from a particular flow of packets with a second probability if:
the particular packet is not accepted by the dedicated queue associated with the particular flow,
the size of the used portion of the shared queue is less than or equal to the shared threshold, and
the size of the used portion of the shared queue portion is greater than the flow threshold associated with the particular flow;
wherein the first probability is less than the second probability.

19. An apparatus for buffer memory management in a packet-switching application, the apparatus including a processor and memory connected to the processor, wherein the processor comprises one or more components to:
associate each of a plurality of flows of packets with a dedicated queue, and a particular portion of a shared queue to provide a size of a combination of the dedicated queues and the shared queue portions for all of the flows exceeding an amount of physical memory available to buffer packets, and
accept a particular packet from a particular flow of packets into the dedicated queue associated with the particular flow if a size of an unused portion of the dedicated queue associated with the particular flow is greater than or equal to a size of the particular packet.

20. The apparatus of claim 19 wherein the size of the dedicated queue varies for different flows.

21. The apparatus of claim 19 wherein the size of the dedicated queue is the same for all flows.

22. The apparatus of claim 19, the processor being further comprises one or more components to:
set a shared threshold that is less than or equal to a size of the shared queue, and
accept a particular packet from a particular flow of packets into the shared queue if the particular packet is not accepted by the dedicated queue associated with the particular flow, a size of an unused portion of the shared queue portion associated with the particular flow is greater than or equal to the size of the particular packet, and a size of a used portion of the shared queue is less than or equal to the shared threshold.

23. The apparatus of claim 22, the processor being further comprising one or more components to drop a particular packet from a particular flow of packets if the particular packet is not accepted by the dedicated queue associated with the particular flow and a size of a used portion of the shared queue is greater than the shared threshold.

24. The apparatus of claim 22, the processor being further comprising one or more components to drop a particular packet from the particular flow of packets if the particular packet is not accepted by the dedicated queue associated with the particular flow and the size of the unused portion of the shared queue portion associated with the particular flow is less than the size of the particular packet.

25. The apparatus of claim 22, the processor further comprising one or more components to:
associate each flow of packets with a flow threshold, and
drop a particular packet from the particular flow of packets if the particular packet is not accepted by the dedicated queue associated with the particular flow and a size of the used portion of the shared queue portion associated with the particular flow is greater than the flow threshold associated with the particular flow.

26. The apparatus of claim 19, the processor further comprising one or more components to:
associate each received packet with a probability of being accepted into the shared queue,
accept a particular packet from a particular flow of packets into the shared queue if the particular packet is not accepted by the dedicated queue associated with the particular flow and the probability associated with the particular packet is greater than the probability associated with one or more other received packets that have not been accepted by the dedicated queues associated with the flows of the received packets, and
drop a particular packet from a particular flow of packets if the particular packet is not accepted into the dedicated queue associated with the particular flow and the particular packet is not accepted into the shared queue.

27. The apparatus of claim 26, wherein the shared threshold is less than the size of the shared queue, the processor being further comprising one or more components to:
associate each flow of packets with a flow threshold;
associate a particular packet from a particular flow of packets with a first probability if:
the particular packet is not accepted by the dedicated queue associated with the particular flow,
the size of the used portion of the shared queue is greater than the shared threshold, and
the size of the used portion of the shared queue portion is less than or equal to the flow threshold associated with a particular flow; and
associate a particular packet from a particular flow of packets with a second probability if:
the particular packet is not accepted by the dedicated queue associated with the particular flow,
the size of the used portion of the shared queue is less than or equal to the shared threshold, and
the size of the used portion of the shared queue portion is greater than the flow threshold associated with the particular flow;
wherein the first probability is less than the second probability.

28. A system for buffer memory management in a packet-switching application, the system comprising:
a traffic management device;
a port coupled to a transmission channel; and
a link between the traffic management device and the port,
wherein the traffic management device is comprised of one or more components to:
associate each of a plurality of flows of packets with a dedicated queue and a particular portion of a shared queue to provide a size of a combination of the dedicated queues and the shared queue portions for all of the flows exceeding an amount of physical memory available to buffer packets, and
accept a particular packet from a particular flow of packets into the dedicated queue associated with the particular flow if a size of an unused portion of the dedicated queue associated with the particular flow is greater than or equal to a size of the particular packet.

29. The system of claim 28 wherein the traffic management device is further comprised of one or more components to:
set a shared threshold that is less than or equal to a size of the shared queue, and
accept a particular packet from a particular flow of packets into the shared queue if the particular packet is not accepted by the dedicated queue associated with the particular flow, a size of an unused portion of the shared queue portion associated with the particular flow is greater than or equal to the size of the particular packet, and a size of a used portion of the shared queue is less than or equal to the shared threshold.

30. The system of claim 29 wherein the traffic management device is further comprised of one or more components to:
drop a particular packet from a particular flow of packets if the particular packet is not accepted by the dedicated queue associated with the particular flow and a size of a used portion of the shared queue is greater than the shared threshold, and
drop a particular packet from the particular flow of packets if the particular packet is not accepted by the dedicated queue associated with the particular flow and the size of the unused portion of the shared queue portion associated with the particular flow is less than the size of the particular packet.
